(19) United States
(12) Patent Application Publication
(10) Pub. No.: US 2006/0083266 A1
(43) Pub. Date: Apr. 20, 2006

(54) Initial access signaling method in synchronous ethernet device

(75) Inventors: Se-Youn Lim, Seoul (KR); Jae-Yeon Song, Seoul (KR); Seo-Won Kwon, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/222,178

(22) Filed: Sep. 8, 2005

(30) Foreign Application Priority Data
Oct. 19, 2004 (KR) 2004-83573

(51) Int. Cl. H04J 3/06

(52) U.S. Cl. 370/503

(57) ABSTRACT

Disclosed is an initial access signaling method in a synchronous Ethernet device. The initial access signaling method in a synchronous Ethernet device is provided to determine if the synchronous Ethernet device can perform a synchronous Ethernet operation together with a counterpart device connected to the synchronous Ethernet device in order to provide a compatibility between the synchronous Ethernet and the conventional Ethernet.

### CLAIM OF PRIORITY

This application claims priority to an application entitled “Initial access Signaling Method in Synchronous Ethernet Device,” filed in the Korean Intellectual Property Office on Oct. 19, 2004 and assigned Serial No. 2004-83573, the contents of which are incorporated herein by reference.

### BACKGROUND OF THE INVENTION

1. Field of the Invention

The present invention relates to an initial signaling method for providing compatibility with a typical Ethernet device in a synchronous Ethernet, which is capable of providing a real-time service and a non-real time service at the same time.

2. Description of the Related Art

Ethernet has been standardized recently by Institute of Electrical and Electronics Engineers (IEEE) 802.3. The conventional Ethernets utilizes a carrier sense multiple access/collision detect (CSMA/CD) protocol defined in IEEE 802.3 to gain an access. As such, an upper class service frame is first transmitted as an Ethernet frame during operation while maintaining the Inter Frame Gap (IFG). The frames may be transmitted according to a frame generation sequence regardless of the type of the upper service frames.

Ethernet is not suitable for transmitting a moving picture or a voice sensitive to a transmission time delay. However, recently, a technique of transmitting synchronous data such as video data/voice data using the conventional Ethernet, or known as a synchronous Ethernet, has been actively discussed.

In the synchronous Ethernet, a frame is transmitted based on a cycle. Generally, one cycle is 125 μs and divided into a first duration in which synchronous frames can be transmitted and a second duration in which asynchronous frames can be transmitted. The synchronous frames correspond to fixed-length Ethernet frames, and the asynchronous frames correspond to variable-length Ethernet frames.

FIG. 1 is a view illustrating a structure of a transmission cycle according to a typical synchronous Ethernet.

The synchronous Ethernet under a current discussion transmits data with a transmission cycle 10 of 125 μsec, in which each transmission cycle includes a Sync module 100 for transmitting synchronous data and an Async module 110 for transmitting asynchronous data. The Sync frame module 100 for transmission of synchronous data has the highest priority in the transmission cycle and includes 738-byte sub frames 101, 102, and 103 according to a proposal under the current discussion (herein, the proposal is changeable). The Async frame module 110 for transmission of the asynchronous data includes sub-asynchronous frames 111, 112, and 113 having a variable length in a corresponding area.

According to the above synchronous Ethernet, synchronous frames are transmitted separately from asynchronous frames. Hence, synchronous signaling protocol must be considered when transmitting the synchronous frames. In addition, since the asynchronous frames have a lower priority than that the synchronous frames, the above synchronous Ethernet causes a compatibility problem with the conventional Ethernet, which allocates the same priority to all frames input thereto.

Until now, there has never been suggested a technique for supporting compatibility between devices supporting the conventional Ethernet and devices supporting the synchronous Ethernet.

### SUMMARY OF THE INVENTION

Accordingly, the present invention has been made to solve the above-mentioned problems occurring in the prior art and provides additional advantages, by providing an initial access signaling method used in a synchronous Ethernet device to determine if the synchronous Ethernet device can perform a synchronous Ethernet operation with another device while maintaining a compatibility between the synchronous Ethernet and the conventional Ethernet.

In one embodiment, there is provided an initial access signaling method for determining an operation state of a predetermined device when a synchronous Ethernet device is connected to the predetermined device. The initial access signaling method includes the steps of (1) detecting a connection between the predetermined device and the synchronous Ethernet device, (2) transmitting a first initial access signaling message to the predetermined device to determine if the predetermined device supports a synchronous Ethernet, (3) determining if a second initial access signaling message is received from the predetermined device as the connection is established between the predetermined device and the synchronous Ethernet device, (4) indicating that an operation is performed through a synchronous Ethernet scheme and transmitting a response message in response to the second initial access signaling message if the second initial access signaling message has been received from the predetermined device, and (5) performing the operation through an Ethernet scheme if the second initial access signaling message is not received from the predetermined device.

### BRIEF DESCRIPTION OF THE DRAWINGS

The above features and advantages of the present invention will be more apparent from the following detailed description taken in conjunction with the accompanying drawings, in which:

FIG. 1 illustrates an example of a transmission cycle according to a typical synchronous Ethernet;

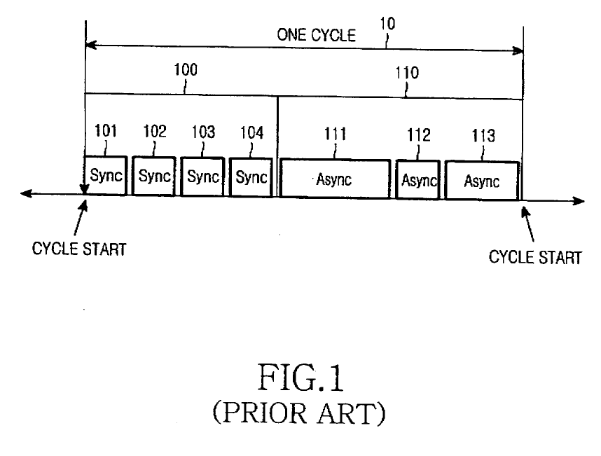

FIG. 2 illustrates a scenario where a synchronous Ethernet device according to one embodiment of the present invention is coupled to other Ethernet devices;

FIG. 3 is a timing chart illustrating a synchronous Ethernet-based connection procedure using an initial access signaling method according to one embodiment of the present invention;

FIG. 4 is a timing chart illustrating the conventional Ethernet scheme-based connection procedure using an initial access signaling method according to an embodiment of the present invention;

FIG. 5 illustrates a structure of an initial access signaling message of a synchronous Ethernet device according to an embodiment of the present invention; and

FIG. 6 is a flowchart illustrating an initial access signaling operation of a device supporting a synchronous Ethernet according to an embodiment of the present invention.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

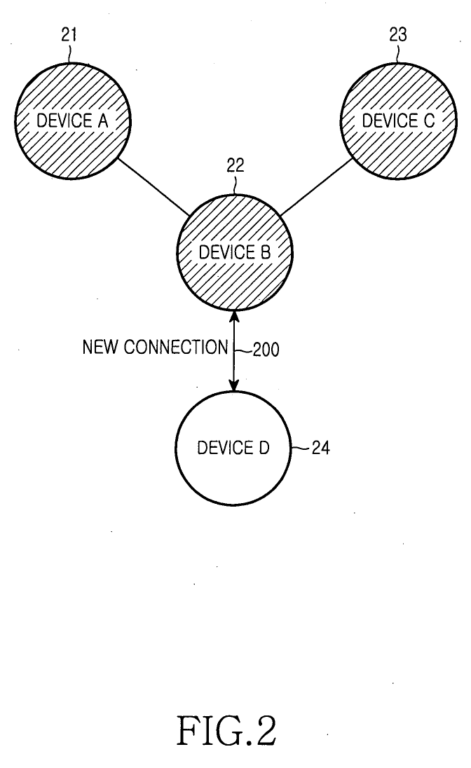

FIG. 2 shows a synchronous Ethernet device and other Ethernet devices whereto the embodiment of the present invention may be applied. In particular, FIG. 2 illustrates a case where a device D 24 is newly connected to an Ethernet made of a device A 21, a device B 22, and a device C 23.

In operation, if the device A 21, the device B 22, and the device C 23 are synchronous Ethernet devices and if the newly connected device D 24 is also a synchronous Ethernet device, data are transmitted through a synchronous Ethernet scheme.

If the device A 21, the device B 22, and the device C 23 are convention Ethernet devices, and if the newly connected device D 24 is also a conventional Ethernet device, data are transmitted through a conventional Ethernet scheme.

However, if the device A 21, the device B 22, and the device C 23 are synchronous Ethernet devices, but if the newly connected device D 24 is a conventional Ethernet device, it is difficult to recognize a data transmission/reception scheme. Similarly, if the device A 21, the device B 22, and the device C 23 are conventional Ethernet devices, and the newly connected device D 24 is a synchronous Ethernet device, it is difficult to recognize a data transmission/reception scheme also. As a result, data transmission/reception between the different Ethernet devices is not achieved.

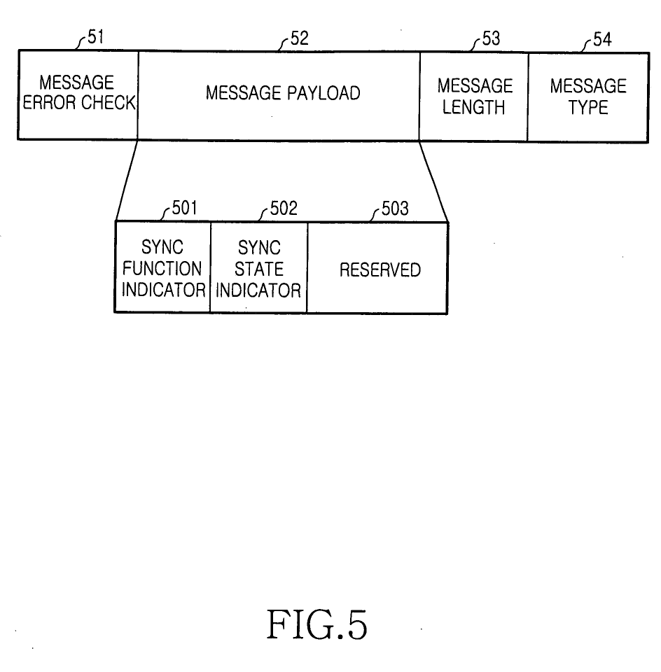

Therefore, according to the teachings of the present invention, when Ethernet devices are connected to each other, a signaling procedure of obtaining information about whether or not the counterpart device supports a synchronous Ethernet scheme, and information about a current operation scheme and a signaling message used for the signaling procedure are defined. An initial access signaling message used according to the embodiment of the present invention is shown in FIG. 5.

FIG. 5 illustrates a structure of the initial access signaling message of a synchronous Ethernet device according to the present invention and includes a message error check field 51 expressed as a value capable of determining if errors exist in a total message and is used for error checking in a receiver, a message length field 53 represents the length of the initial access signaling message of the synchronous Ethernet device, a message type field 54 represents the type of the initial access signaling message of the synchronous Ethernet device, and a message payload field 52 including message contents corresponds to the type of the message type field 54.

The value of the message length field 53 varies with the characteristics of messages, and the exact lengths of the message are not expressed. In addition, the message type field 54 has a value representing a “Hello message” for an initial access signaling message.

The message payload field 52 further includes a synch-capa-indicator 501 used for representing if a synchronous Ethernet scheme is supported, a synchronous state indicator 502 used for indicating a synchronous Ethernet state upon receiving an initial access signaling message including the Sync-capa-indicator 501 from the counterpart device, and a reserved field 503. The reserved field 503 may include a master/slave type indicator field, which is used for representing if a device is a timing master or a timing slave. A device operating as a timing master outputting a synchronous timing signal for synchronization of the entire system is expressed as a master, and a device that do not operate as the timing master is expressed as a slave. The value of the master/slave type indicator field is determined through an algorithm for determining a master and a slave when it is recognized that both devices connected to each other support a synchronous Ethernet. A method of determining the master and the slave is generally well know to those skilled in the art, thus omitted to avoid redundancy.

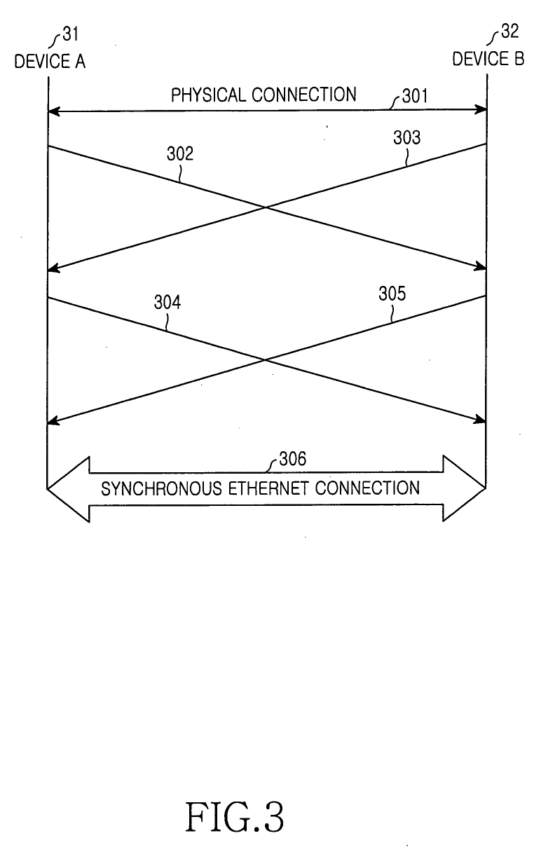

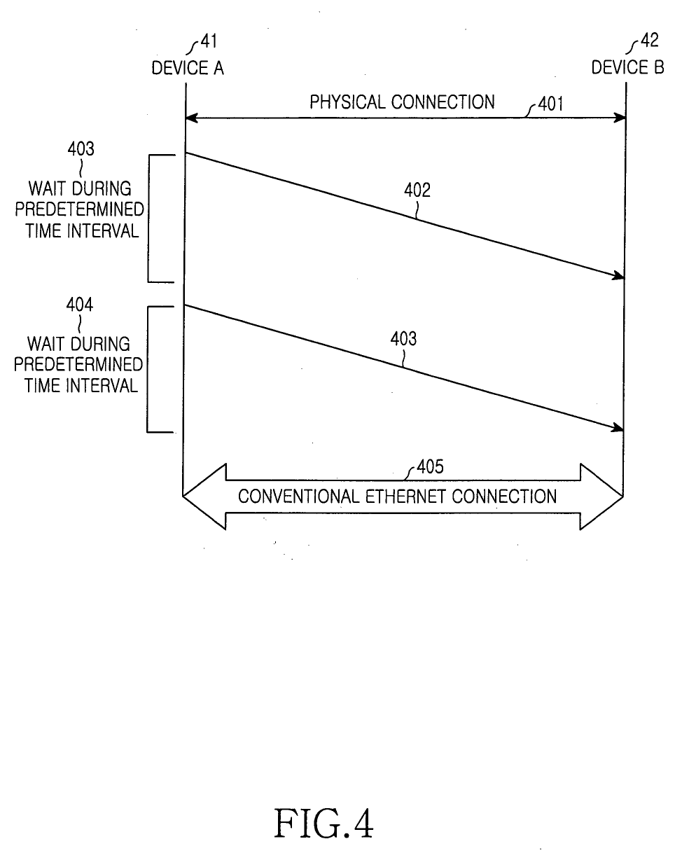

Now, the operation performed when devices are connected to each other using the initial access signaling message is shown in FIGS. 3 and 4.

FIG. 3 is a timing chart illustrating a synchronous Ethernet-based connection process using an initial access signaling method of a synchronous Ethernet device according to the present invention.

Briefly, if the device A 31 and the device B 32 are physically connected to each other (step 301), the devices 31 and 32 transmit initial access signaling messages, respectively, (step 302 and step 303). Thereafter, each of the devices 31 and 32 transmits a response message in response to the initial access signaling message received from the counterpart device (step 304 and step 305). Thereafter, the devices 31 and 32 establish a data communication through a synchronous Ethernet connection between the devices 31 and 32 (step 306).

Hereinafter, the above operation in each device will be described in more detail with reference to FIGS. 3 and 5.

In FIG. 3, it is assumed both the device A 31 and the device B 32 support a synchronous Ethernet.

The device A 31 is physically connected to the device B 32 (step 301) and transmits an initial access signaling message within a predetermined period of time (step 302).

The device A 31 indicates in the Sync-capa-indicator field 501 of the message payload field 52 shown in FIG. 5 that the device A 31 supports a synchronous Ethernet and indicates in the Sync state indicator field 502 that the device A 31 is not in a synchronous Ethernet operation state. In addition, when the master/slave time indicator field exists, the device A 31 sets a default value in the master/slave time indicator field to be transmitted. This is performed as the device A 31 and the device B 32 are independent devices from each other. Accordingly, it is assumed that a master and a slave are not determined.

The device A 31 receives an initial access signaling message from the device B 32 (step 303). Herein, the initial access signaling message received from the device B 32 has the same field values as the initial access signaling message described in step 301. This is because it has been assumed that the device A 31 and the device B 32 are independent from each other, and the two devices support a synchronous Ethernet technique. Accordingly, their initial access signaling messages are identical to each other.

Thereafter, the device A 31 generates a response message in response to the initial access signaling message (step 303) received from the device B 32 (step 304) and transmits a response message to the device B. In this case, the response message has the same structure as the initial access signaling message. Accordingly, the device A 31 indicates in the Sync-capa-Indicator field 501 of the message payload field 52 of the response message that the device A 31 supports a synchronous Ethernet. In addition, since the device A 31 has recognized that the device B 32 can support a synchronous Ethernet based on the initial access signaling message 303 received from the device B 32, the device A 31 indicates in the Synch state indicator field 502 of the response message that the device A 31 operates as a synchronous Ethernet device.

The device A 31 receives a response message from the device B 32 (step 305) so as to establish a communication based on a synchronous Ethernet scheme (step 306).

Similarly, when the device B 32 is physically connected to the device A 31 (step 301), an initial access signaling message is transmitted within a predetermined time period (step 303).

The device B 32 expresses in the Sync-capa-indicator field 501 of the message payload field 52 shown in FIG. 5 that the device B 32 supports a synchronous Ethernet and expresses in the Sync state indicator field 502 that the device B 32 is not in a synchronous Ethernet operation state. If the master/slave time indicator field exists, the device B 32 sets a default value in the master/slave time indicator field to be transmitted. Here, it is assumed that a master and a slave are not determined.

The device B 32 receives an initial access signaling message from the device B 31 (step 302) which has the same field values as the initial access signaling message described in step 302. This is because it has been assumed that the device A 31 and the device B 32 are independently connected to each other, and the two devices support a synchronous Ethernet technique. Accordingly, their initial access signaling messages are identical to each other.

Thereafter, the device B 32 generates a response message in response to the initial access signaling message (step 302) received from the device A 31 and transmits the response message for the device B (step 305). In this case, the response message has the same structure as the initial access signaling message according to the present invention. Accordingly, the device B 32 indicates in the Sync-capa-Indicator field 501 of the message payload field 52 of the response message that the device B 32 supports a synchronous Ethernet. In addition, since the device B 32 has recognized that the device A 31 can support a synchronous Ethernet based on the initial access signaling message 302 received from the device A 31, the device B 32 indicates in the Synch state indicator field 502 of the response message that the device B 32 operates as a synchronous Ethernet device.

Thereafter, the device B 32 receives a response message from the device A 31 (step 304) so as to establish a communication based on a synchronous Ethernet scheme (step 306).

Note that if a master and a slave time indicator is provided between the device A 31 and the device B 32, response messages in steps 304 and 305 express an operation type of a corresponding device determined according to the method of determining a master/slave. Herein, a device operating as a master transmits a synchronous clock to the counterpart device when making a synchronous Ethernet communication in step 306.

FIG. 4 is a timing chart illustrating the conventional Ethernet scheme-based connection process using an initial access signaling method of a synchronous Ethernet device in accordance with the present invention.

If the device A 41 and the device B 42 are physically connected to each other (step 401), the device A 41 supporting a synchronous Ethernet transmits an initial access signaling message according to the present invention (step 402). Thereafter, the device A 41 waits for an initial access signaling message from the counterpart of the device A 41. If the initial access signaling message from the counterpart of the device A 41 is not received during a predetermined time interval (step 403), the device A 41 re-transmits the initial access signaling message. The device A 41 repeats the above-described steps a number of times set by a system. Thereafter, the device A 41 determines that the device B 42 connected to the device A 41 does not support a synchronous Ethernet and makes a data communication by connecting to the device B 42 through the conventional Ethernet scheme (step 405). Herein, as the device B 42 does not recognize the initial access signaling message, no operation relating to a synchronous Ethernet is performed.

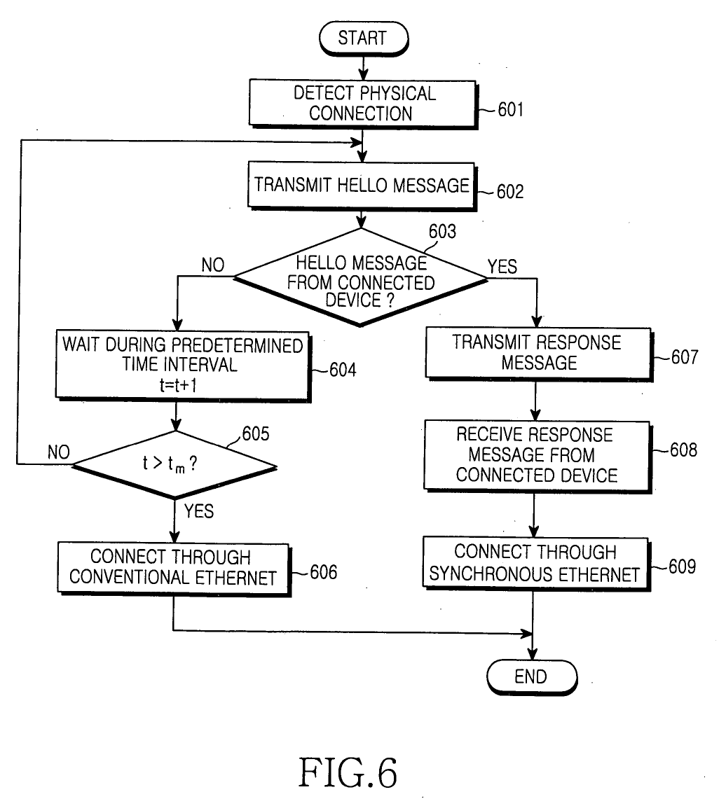

FIG. 6 is a flowchart illustrating an initial access signaling operation of a device supporting a synchronous Ethernet according to the present invention.

The device supporting a synchronous Ethernet according to the present invention detects a physical connection (step 601) and transmits a Hello message (an initial access signaling message according to the present invention) to the counterpart device of the physical connection (step 602). The device is controlled by operating a timer so that the device does not wait for a Hello message from the counterpart device during at least a predetermined threshold time interval (tₘ).

The device determines if there is a Hello message from the counterpart device of the physical connection (step 603).

If there is no Hello message from the counterpart device (step 603), the device waits for the Hello message for another predetermined time interval. The device is controlled by operating a timer such that the device does not wait for a Hello message from the counterpart device during at least a predetermined threshold time interval (tₘ) (steps 604 and 605).

If a total waiting time interval does not exceed a predetermined threshold time interval (tₘ) in step 605, the device re-transmits a Hello message in step 602. However, if the total waiting time interval exceeds the predetermined threshold time interval (tₘ), the device determines that the counterpart device of the physical connection does not support a synchronous Ethernet and establishes a data communication through the conventional Ethernet scheme (step 606).

If there is a Hello message from the counterpart device (step 603), the device transmits a response message for the Hello message (step 607). Thereafter, the device receives from the counterpart device a response message for the Hello message having been transmitted in step 602 (step 608) and is connected to the counterpart device through a synchronous Ethernet scheme (step 609).

As described above, according to the present invention, a compatibility between a synchronous Ethernet and a typical Ethernet is provided, so that it is possible to establish a communication between the synchronous Ethernet and the typical Ethernet without the need for replacing a system. Further, it should be noted that the method according to the present invention can be realized by a program and can be stored in a recording medium (such as a CD ROM, a RAM, a floppy disk, a hard disk, an optical and magnetic disk, etc.) in a format that can be read by a computer.

While the invention has been shown and described with reference to certain preferred embodiments thereof, it will be understood by those skilled in the art that various changes in form and details may be made therein without departing from the spirit and scope of the invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. An initial access signaling method for determining an operation state of a predetermined device when a synchronous Ethernet device is coupled to the predetermined device, the initial access signaling method comprising the steps of:
(1) detecting a connection between the predetermined device and the synchronous Ethernet device;
(2) transmitting a first initial access signaling message to the predetermined device for determining if the predetermined device supports a synchronous Ethernet;
(3) determining if a second initial access signaling message is received from the predetermined device as the connection is established between the predetermined device and the synchronous Ethernet device;
(4) indicating that an operation is performed through a synchronous Ethernet scheme and transmitting a response message for the second initial access signaling message if the second initial access signaling message has been received from the predetermined device; and
(5) establishing a link using an Ethernet scheme if the second initial access signaling message is not received from the predetermined device.

2. The initial access signaling method as claimed in claim 1, wherein the first initial access signaling message comprises:
a synchronous capability indicator (Sync-Capa-Indicator) field for indicating if the synchronous Ethernet device supports a synchronous Ethernet scheme;
a synchronous state indicator field for indicating if a current operation state of the synchronous Ethernet device is a synchronous Ethernet state; and
a reserved field.

3. The initial access signaling method as claimed in claim 1, wherein the second initial access signaling message comprises:
a synchronous capability indicator (Sync-Capa-Indicator) field for indicating if the predetermined Ethernet device supports a synchronous Ethernet scheme;
a synchronous state indicator field for indicating if a current operation state of the predetermined Ethernet device is a synchronous Ethernet state; and
a reserved field.

4. The initial access signaling method as claimed in claim 1, wherein the response message comprises:
a synchronous capability indicator (Sync-Capa-Indicator) field for indicating if the synchronous Ethernet device supports a synchronous Ethernet scheme;
a synchronous state indicator field for indicating if a current operation state of the synchronous Ethernet device is a synchronous Ethernet state; and
a reserved field, wherein the synchronous state indicator field indicating the synchronous Ethernet state is transmitted.

5. The initial access signaling method as claimed in claim 2, wherein the reserved field comprises a master/slave type indicator field for indicating a device providing a synchronous timing clock of a synchronous Ethernet system.

6. The initial access signaling method as claimed in claim 3, wherein the reserved field comprises a master/slave type indicator field for indicating a device providing a synchronous timing clock of a synchronous Ethernet system.

7. The initial access signaling method as claimed in claim 4, wherein the reserved field comprises a master/slave type indicator field for indicating a device providing a synchronous timing clock of a synchronous Ethernet system.

8. The initial access signaling method as claimed in claim 2, wherein step (5) comprises the steps of:
repeating steps (2) to (4) if the second initial access signaling message is not received from the predetermined device for a first predetermined time interval within a second predetermined time interval after the first initial access signaling message has been transmitted in step (2); and
determining the predetermined device as an Ethernet device and performing an operation through the Ethernet scheme if the second initial access signaling message is not received from the predetermined device within the second predetermined time interval.

9. The initial access signaling method as claimed in claim 3, wherein step (5) comprises the steps of:
repeating steps (2) to (4) if the second initial access signaling message is not received from the predetermined device for a first predetermined time interval within a second predetermined time interval after the first initial access signaling message has been transmitted in step (2); and
determining the predetermined device as an Ethernet device and performing an operation through the Ethernet scheme if the second initial access signaling message is not received from the predetermined device within the second predetermined time interval.

10. The initial access signaling method as claimed in claim 4, wherein step (5) comprises the steps of:
repeating steps (2) to (4) if the second initial access signaling message is not received from the predetermined device for a first predetermined time interval within a second predetermined time interval after the first initial access signaling message has been transmitted in step (2); and
determining the predetermined device as an Ethernet device and performing an operation through the Ethernet scheme if the second initial access signaling message is not received from the predetermined device within the second predetermined time interval.
